(19) United States
(12) Patent Application Publication
(10) Pub. No.: US 2006/0247023 A1
(43) Pub. Date: Nov. 2, 2006

(54) Symbol displaying unit for game machines

(76) Inventor: Haruo Inoue, Tokyo (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/338,841

(22) Filed: Jan. 25, 2006

(30) Foreign Application Priority Data
Apr. 28, 2005 (JP) 2005-131521

(51) Int. Cl. A63F 13/00

(52) U.S. Cl. 463/25; 463/20

(57) ABSTRACT

The symbol displaying unit for a game machine of the present invention having a first displaying body and second displaying body, capable of combining symbols and driving means, providing at a supporting member and allowing at least either the first displaying body or second displaying body to drive and rotate, includes a second displaying surface of the second displaying body appearing from an outer circumferential end of a first displaying surface of the first displaying body; and the first displaying body, capable of revolving against the second displaying surface of the second displaying body when a drive motor, defining as an eccentric revolving mechanism, for orbital motion drives and capable of rotating when a drive motor for rotation drives. Therefore, it can expand the moving range of the first displaying body to the displaying surface of the second displaying body, and the displaying body can rotate by itself so that it have a strong appeal to the player visually.

### CROSS-REFERENCE TO RELATED APPLICATIONS

This application is based on Japanese Patent Application 2005-131521 filed on Apr. 28, 2005, upon which priority is claimed.

### BACKGROUND OF THE INVENTION

### Field of the Invention

The present invention relates to a symbol displaying unit for game machines, and more particularly such a symbol displaying unit for game machines which can be decided the prize status, continuation of a game, dividend and other factors according to the combination with a first movable displaying body and a second fixable or movable displaying body.

The reference documents 1 and 2 disclose an eccentric revolving mechanism for pushing the medals, including means for driving, means for transmitting power and rotor plate. However, the medal pusher is a member to drop a plurality of coins which are put on a game board in a dropping part positioned in a multi-direction.

Compared with features of the reference documents 1, 2 and the present invention, the medal pushers disclosed in the reference documents 1 and 2 are defined by a device to drop the coins in the multi-direction. On the other hand, the movable displaying body of the present invention is defined as means for displaying symbol for combination.

Additionally, the medal pushers disclosed in the reference documents 1 and 2 rotates and have an eccentric rotation by driving force of one drive motor in the eccentric revolving mechanism. On the other hand, the drive motor for orbital motion in the eccentric revolving mechanism for movable displaying body in the present invention is different from the drive motor for rotation which makes the movable displaying body to rotate independently.

In other words, the movable displaying body of the present invention can orbit by driving force of the drive motor for orbital motion and can rotate by driving force of the drive motor for rotation which is different from the drive motor for orbital motion. In fact, the movable displaying body of the present invention can be operated in many ways depending on execution program of the game machine which is not the limited element in the present invention.

Additionally, reference document 3 relates to the symbol displaying unit for game machines (intended purpose is the same) as the same as the present invention. However, for the displaying body disclosed in the reference document 3, the rod-shaped center shaft for the first displaying body is inserted and passed through the pipe-shaped outer sleeve shaft for the second displaying body so that the center shaft for the first displaying body and outer sleeve shaft for the second displaying body are defined the center shaft of the displaying body (each shaft is fitted coaxially).

Accordingly, the invention disclosed in the reference document 3 has a problem that it does not make the small first displaying body to move widely in a radial direction to the displaying surface of the large second displaying body. In addition, each displaying body just rotates coaxially so that it lacks the idea. Therefore, currently, there is demand for improvement of the moving rage and moving mode of the small first displaying body.

Reference document 1: U.S. Pat. No. 5,275,402;

Reference document 2: U.S. Pat. No. 5,622,366 (Japanese published unexamined application No. Heisei 10-15237); and

Reference document 3: U.S. Published Application No. 2004/0018866A1 (Japanese published unexamined application No. 2004-57374).

### BRIEF SUMMARY OF THE INVENTION

It is an object of the present invention to provide a symbol displaying unit for game machines which provided the drive motor for orbital motion and drive motor for rotation separately and independently and can make the movement of the movable displaying body to change to resolve the problem described in the reference document and have a strong appeal to the player visually. In addition, it can expand the moving range of the small first displaying body to the displaying surface of the large displaying body, for example.

It is another object of the present invention to provide a symbol displaying unit for game machines that can raise the hopes of the players for the games (it is called the device allows the player to excite). It is further object of the present invention to provide a symbol displaying unit for game machines that assembles each parts as one unit and can install into a chassis (case) easily.

For the present invention, the symbol displaying unit for a game machine having a first displaying body and a second displaying body, capable of combining symbols and means for driving, providing at a supporting member and allowing at least either the first displaying body or second displaying body to drive and rotate, includes a second displaying surface of the second displaying body appearing from an outer circumferential end of a first displaying surface of the first displaying body; and the first displaying body, capable of revolving against the second displaying surface of the second displaying body when a drive motor, defining as an eccentric revolving mechanism, for orbital motion drives and capable of rotating when a drive motor for rotation drives.

In addition, the symbol displaying unit for a game machine having a plurality of displaying bodies and means for driving, allowing at least one displaying body to display successively, includes the displaying bodies further including a large displaying body and a small displaying body, the small displaying body having a displaying surface capable of revolving against a displaying surface of the large displaying body by driving force of means for driving for orbital motion and rotating by driving force of means for driving for rotation.

The present invention is understood to encompass embodiments which include all or only a portion of the above objects, features and advantages which, unless recited in claims defining the invention, are understood not to limit interpretation of such claims. The above, and other objects, features and advantages of the present invention will become apparent from the following description read in conjunction with the accompanying drawings, in which like reference numerals designate the same elements.

It is to be expressly understood, however, that the drawings are for the purpose of illustration and description only, and are not intended as a definition of the limits of the invention.

### BRIEF DESCRIPTION OF THE SEVERAL VIEWS OF THE DRAWING

FIGS. 1 to 7 illustrate the explanation view respectively showing the first embodiment of the present invention. FIGS. 8 to 11 illustrate the explanation view respectively showing the second embodiment of the present invention. FIGS. 12 and 13 illustrate the explanation view respectively showing the third embodiment of the present invention.

FIG. 1 is a schematic explanation view (one example which is suitable for a slot machine) showing the condition of example of the invention;

FIG. 2 is an explanation view in the front showing an example of a displaying body;

FIG. 3 is an exploded perspective view of main parts except for some parts (supporting plate of a second displaying body and means for lighting);

FIG. 4 is a schematic explanation view of a main part of the present invention;

FIG. 5 is an explanation view of a large displaying body (second displaying body) including some parts (supporting plate of a second displaying body, lighting means);

FIG. 6 is a schematic explanation view of other member (means for detecting a rotating position);

FIG. 7 is a schematic explanation view showing the way in which a movable displaying body (first displaying body) orbits;

FIG. 8 is a schematic explanation view of a main part in a second embodiment;

FIG. 9 is an exploded perspective view of main parts except for some parts (supporting plate of a second displaying body and means for lighting);

FIG. 10 is an is an explanation view of a large displaying body (second displaying body) including some parts (supporting plate of a second displaying body, lighting means);

FIG. 11 is an explanation view showing the way in which a lighting area to a small displaying body is given a half-tone dot meshing when in orbital motion;

FIG. 12 is a schematic perspective view showing a third embodiment; and

FIG. 13 is a schematic explanation view of a main part in a third embodiment.

### DETAILED DESCRIPTION OF THE INVENTION

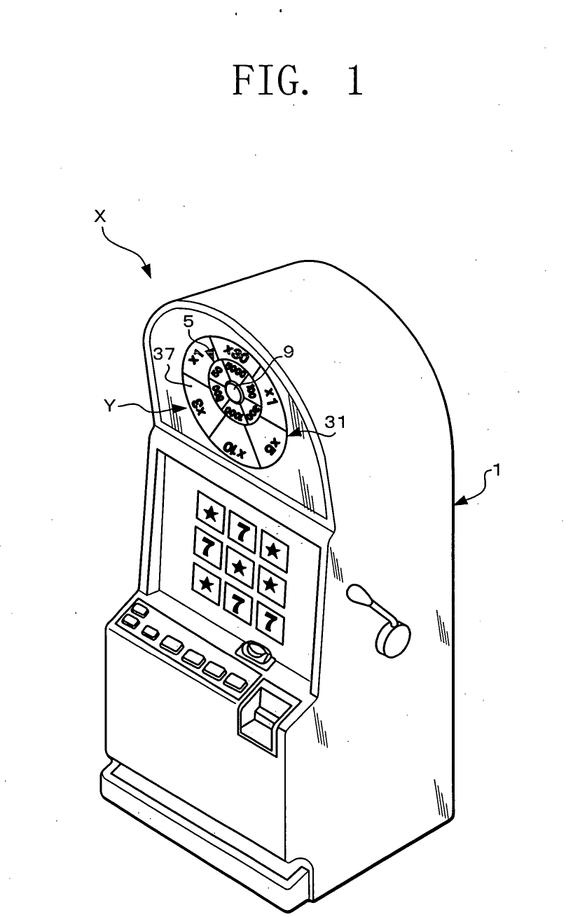

Preferred embodiments (first embodiment) of the present invention are described in more detail below referring to FIGS. 1 to 7.

(1) Environment of Practice of this Invention—FIG. 1

FIG. 1 is a schematic explanation view showing a condition of an embodiment of the present invention. Reference mark X in FIG. 1 is an example (slot machine) of the game machines. Reference numeral 1 is a case, installing a symbol displaying unit Y for the game machines at a side of an upper portion of the case 1. In addition, although it is the matter which is unrelated to the specific requirements for this invention, the game machine X includes the required member in order to perform game(s), such as a coin saucer, control panel, matrix-shaped display window and control lever, which does not number. The specific requirements for the present invention are omitted as much as possible.

(2) Supporting Member 2

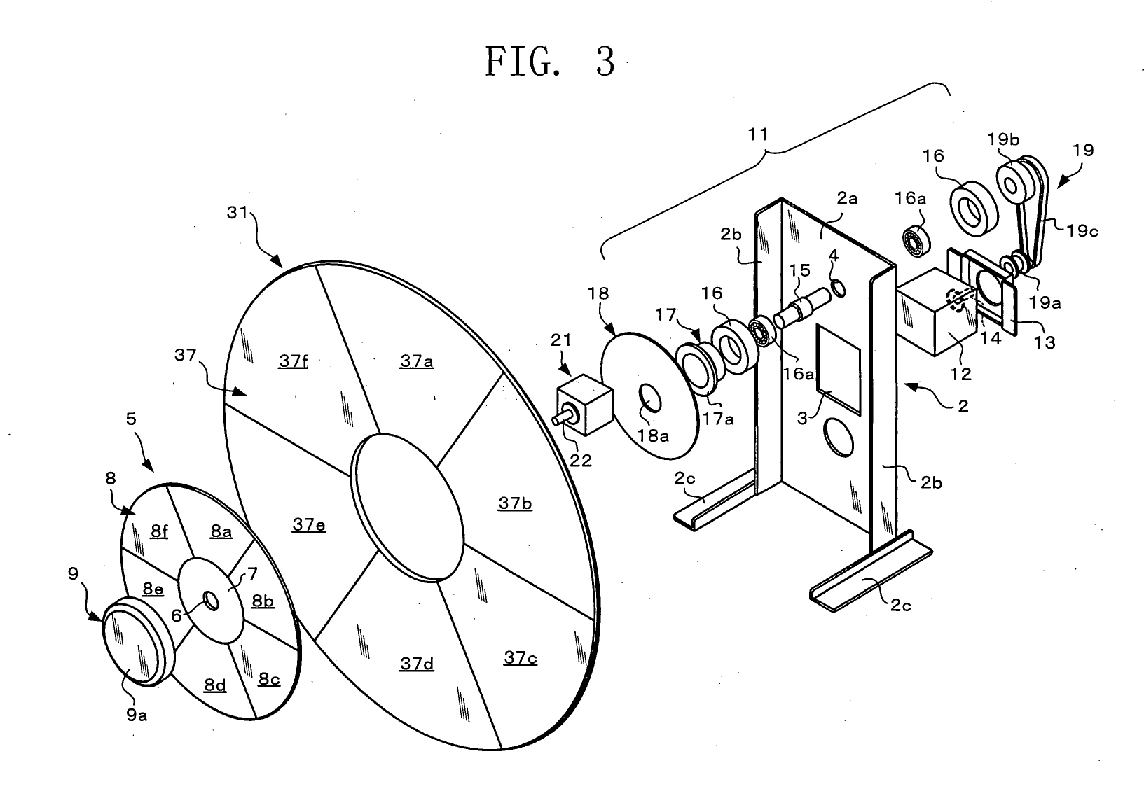

Reference numeral 2 is a large supporting member which is fixed into the case of the game machine. The supporting member 2, as shown in FIG. 3, is comprised of a wide perpendicular plate 2a which is formed in the shape of a rectangle; end plate parts 2b which are formed to bend the end parts of the perpendicular plate 2a; and attachment base plates 2c which are fixed to the lower end part of the end plate parts 2b respectively so as to cross the end plate parts 2b.

The supporting member 2 is defined as a member (base supporting member) to be a base to the supporting plate for forming a unit and attachment piece for the sensor. Therefore, the attachment hole for fixing device is formed accordingly although the numeral is not put in the figure. The concrete description for means for fixing (fixing device, screwed hole, adhesion and the like) is omitted. The supporting member 2 is formed in the shape of a channel in end section in this embodiment, and its shape and material is not limited especially.

Additionally, an opening 3 for a first drive motor 12, which is formed in the shape of a rectangle, is formed at a center portion of the perpendicular plate 2a. In addition, a hole for inserting the center shaft is formed above the opening 3.

(3) First Displaying Body 5 and Holding Member 9

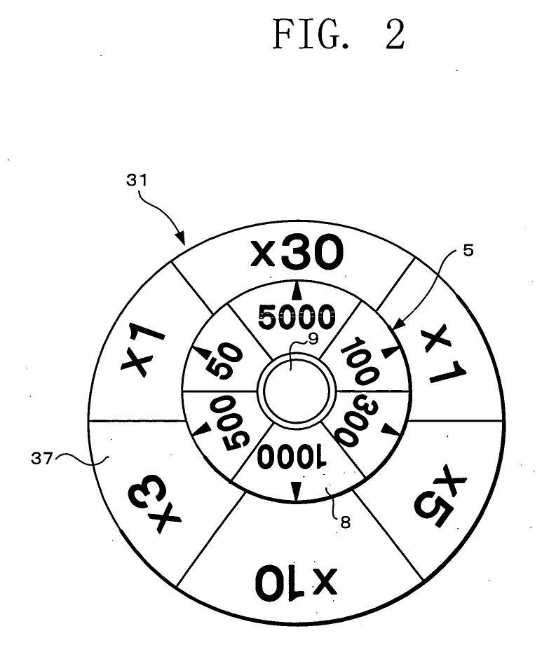

As shown in FIGS. 2 and 3, the small first displaying body 5 in this embodiment is formed in the shape of a disc for example and orbits and rotates on its axis by driving force of the plurality of the drive motors 12, 21 mentioned later. In particular, for the rotating mode of the first displaying body 5, it can orbit in a circumferential direction and can rotates at the same or different time against the second displaying surface 37, which is formed in the shape of a round, having a single or plural symbols, of the large second displaying body 31.

In addition, the first displaying body 5, which is formed in the shape of a disc, rotates by driving force of the first drive motor 12 comprises the eccentric revolving mechanism 11 which is mentioned later. The first drive motor 12 is a drive source to make the first displaying body 5 to orbit to a second displaying body 31 so that it is called “drive motor for orbital motion” hereinafter.

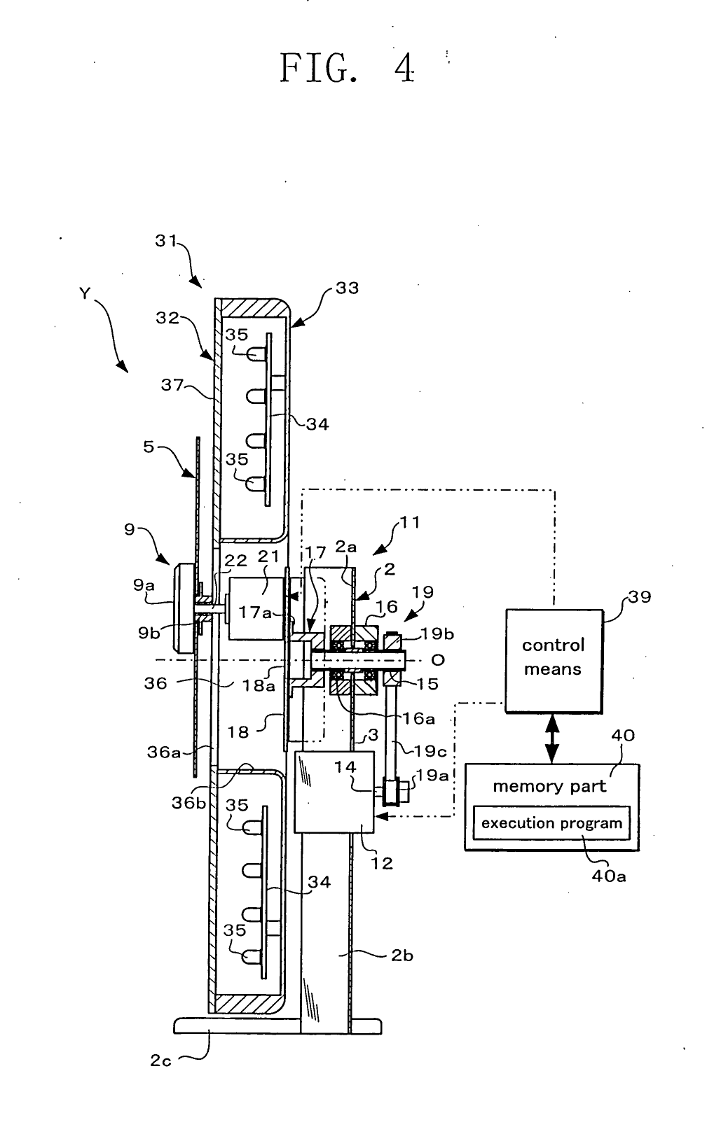

The first displaying body 5 in this embodiment orbits in front of the second displaying body through the rotor plate 18 for eccentric rotation which is provided in front of the supporting member 2 horizontally in regard to an axis O (FIG. 4) of the center shaft 15 which rotates with the drive shaft 14 of the drive motor 12 for orbital motion through means 19 for transmitting power.

In addition, the first displaying body 5 is rotated by driving force of the separated and independent second drive motor 21 which is disposed at a rotor plate 18. The second drive motor 21 is a drive force to make the first displaying body 5 to rotate to the second displaying body 31 so that it is called “drive motor for rotation” hereinafter.

The drive motor 12 for orbital motion and drive motor 21 for rotation are the drive sources independently so that, the first displaying body 5 can rotate itself and orbits to the second displaying body 31; it can rotate in a front portion of the second displaying body 31 after it orbits; or it can orbit to the second displaying body 31 after it rotates in a front portion of the second displaying body 31, depending on the order (contents of the game) of a execution program 40a of means for controlling each drive motor 12, 21.

For the structure of the first displaying body 5, the edge of the first displaying body 5 is formed in the shape of a circle. The circle of the edge includes polygon (pentagon, hexagon, octagon and so on) that is cut the portion of arc.

In addition, the first displaying body 5 further includes a center hole 6 for attaching the holding member 9; a center part 7 which is cover by a cap 9a of the holding member 9, forming in the shape of a circle; and a first displaying surface 8 for combining the symbols, projecting from the outer edge of the cap 9a of the holding member 9 annularly.

The first displaying surface 8, as shown in FIG. 2, has a plurality of symbol displaying areas 8a, 8b, 8c, 8d, 8e, 8f (for example, six areas) which are partitioned off in a radial pattern. Each symbol displaying area is appended numbers for combination, marks, patterns, colors, arrows and the like which are related to the dividend distribution and magnification. As a matter of course, the displaying area is not formed in the first displaying surface 8, and only the symbol for combination may be displayed. In addition, one symbol may be used.

In this embodiment, the holding member 9 is composed of the cap 9a, which is formed in the shape of a small disc, being provided in front of the center part 7 of the first displaying body 5; and a flange 9b which connects integrally to the cap 9a from the back surface of the first displaying body 5 through the center hole 6. Although the number is not put, the flange 9b has a shaft hole, which passes through, providing at the center portion thereof.

(4) Eccentric Revolving Mechanism 11

Each member comprising the eccentric revolving mechanism 11 for the first displaying body 5 is attached to the perpendicular plate 2a of the supporting member 2 through the fixing device which is not illustrated in the figure. At this point, the constructional element of the eccentric revolving mechanism 11 is explained in reference to FIGS. 3 and 4.

Reference numeral 12 is a drive motor for orbital motion. The drive motor 12 is fixed to the perpendicular plate 2a through the opening 3 and a supporting plate 13 for the motor. A drive shaft 14 of the drive motor 12 projects to the backside of the perpendicular plate 2a horizontally. The supporting plate 13 for the motor has flange parts provided at a case part having the opening at the center portion thereof and right and left sides thereof as shown in FIG. 3.

Reference numeral 15 is a center shaft (shaft) which rotates with the drive shaft 14, forming in the shape of a pipe and which is provided above the drive motor 12 horizontally through a hole 4 for the shaft of the perpendicular plate 2a. As shown in FIG. 4, a holding member 16 having a pair of bearings 16a is fixed to the front side and backside of the perpendicular plate 2a.

The center shaft 15 in this embodiment has a large diameter at the center part thereof and a small diameter at both ends thereof. Also it passes through the hole 14 and holding member 16 at a state that is supported rotatably by the holding member 16.

In addition, the supporting plate 17, which is formed in the shape of a hat in section, cap or the like, is fixed to the tip portion of the center shaft 15 through the engaging hole, which projects from the front side of the holding member 16. A flange part 17a is formed at a circumferential edge of the supporting plate 17, and the rotor plate 18, having a center hole 18a, for the eccentric rotation is fixed to the front surface of the flange part 17a. As shown in FIG. 4, the axis O of the center shaft 15 passes through the center hole 18a of the rotor plate 18 for the eccentric rotation.

Reference numeral 19 is the power transmission means which is provided to the drive shaft 14 and center shaft 15 respectively. The power transmission means 19 having a function of speed reduction is comprised of a small pulley 19a fixed to the drive shaft 14; a large pulley 19b which is provided at a side of the rear end part of the center shaft 15; and a transmission belt 19c which is laid on the pulleys. Additionally, the power transmission means 19 may be used a gear transmission mechanism, for example.

(5) Drive Motor for Rotation 21 and First Displaying Body 5

The drive motor for rotation 21 is installed in the front surface of the rotor plate 18 horizontally and fixedly so as to be eccentric to the center shaft 15 on the basis of the center shaft 15 of the eccentric revolving mechanism 11. Accordingly, the drive shaft 22 of the drive motor 21 for rotation stays away from the center hole 18a of the rotor plate 18.

As shown in FIG. 4, the first displaying body 5 is attached to a tip portion of the drive shaft 22 of the drive motor 21 through the holding member 9.

(6) Second Displaying Body

One example of the second displaying body 31 is explained. The second displaying body 31 is formed in the shape of a disc as the same as the first displaying body 5. Outer circumferential part of the second displaying body 31 is formed in the shape of a circle or polygon.

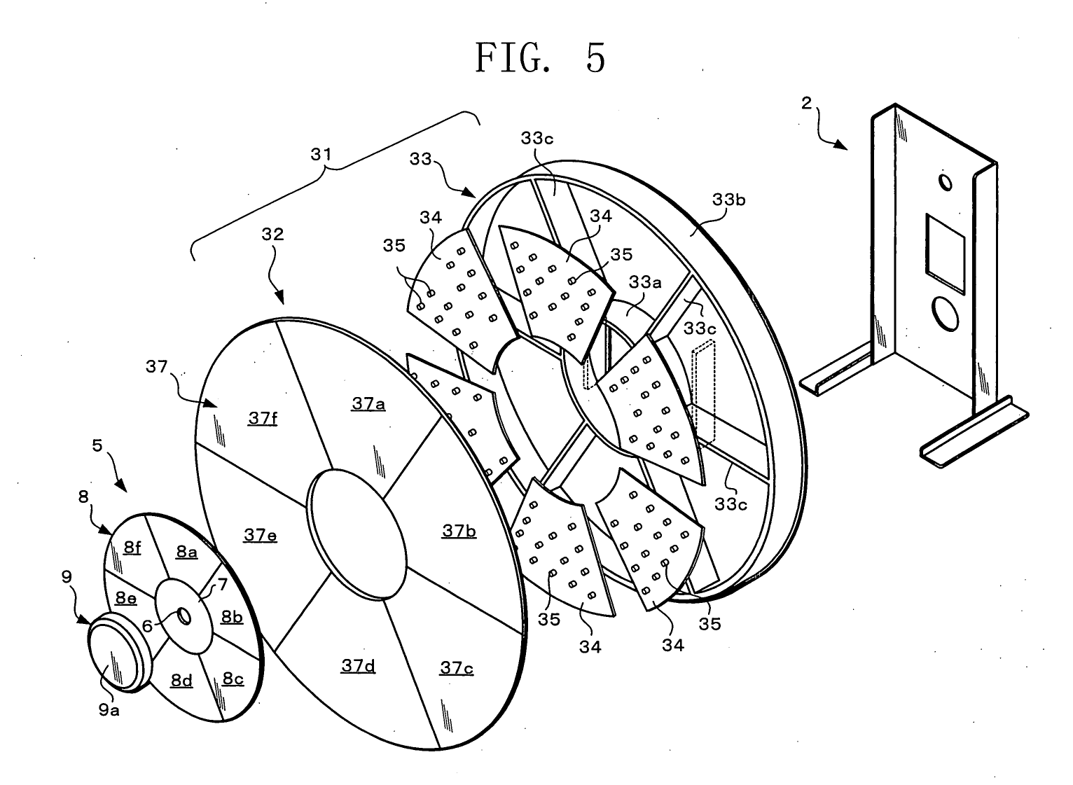

And now, the second displaying body 31 is distinguished from the first displaying body 5 by the fact that it is larger than the first displaying body 5 (FIG. 2); it is fixed to the supporting member 2 of the base (FIG. 4); and the second displaying body 31 is comprised a plurality of parts (FIG. 5).

Then, the second displaying body 31 further includes an annular front plate 32 (FIG. 2) that the second displaying surface 37 always appears from the peripheral border part of the first displaying surface 8 of the first displaying body 5 at an annular state; an annular supporting plate 33 which is fixed to the backside of the front plate 32, having a frame structure; and at least one lighting means 35 which is attached to the supporting plate 33 through at least one reflection plate 34 and can irradiate to the second displaying surface 37 from the back thereof.

Here, the size and shape of the displaying bodies 5, 31 are explained. The outer circumferential end of the first displaying body 8, which is formed in the shape of a plate, is formed in the shape of a circle or polygon. The second displaying body 31 has the center opening 36, and the outer circumferential end thereof always projects from the first displaying surface.

And now, as shown in FIG. 4, second displaying body 31 has the circular opening 36 provided at center part thereof on the basis of the axis O of the center shaft 15. The opening 36 further includes a center opening 36a formed at the front plate 32 and a center opening 36b in inner sleeve part of the supporting plate 33. Accordingly, the drive motor for rotation 21 and drive shaft 22 always positions at an eccentric part in the opening of the second displaying body 31 on the basis of the center (match with the axis O of the center shaft 15) of the center openings 36a, 36b of the second displaying body 31.

As shown in FIG. 5, the annular front plate 32 of the second displaying body 31 has the center opening 36a and annular second displaying surface 37. Whole parts or some parts of the second displaying surface 37 of the front plate 32 in this embodiment are transparent. The transmissive part passes through the light that is irradiated from the lighting means 35, and the light penetrates at a side of the first displaying body 5. In addition, the fact that the front plate 32 is transparent is not the limited element in the first embodiment.

The drive shaft 22 of the drive motor for rotation 21 can rotate clockwise and counterclockwise in the center opening 36a. In addition, the second displaying surface 37 has a plurality of symbol displaying areas 37a, 37b, 37c, 37d, 37e, 37f (for example, six areas) which are partitioned off in a radial pattern as the first displaying surface 8 of the first displaying body 5. Each symbol displaying area is appended numbers for combination, marks, patterns, colors, arrows and the like which are related to the dividend distribution and magnification. As a matter of course, the displaying area is not formed in the second displaying surface 37, and only the symbol for combination may be displayed. In addition, one symbol may be used.

And now, the supporting plate 33 is comprised of an inner sleeve part 33a which is defined by the center opening 36b; an outer sleeve part 33b positioned at the outer side of the inner sleeve part 33a; and a plurality of arms 33c which connects the outer sleeve part 33b and inner sleeve part 33a in a radial pattern. In addition, the reflection plates 34, which are formed in the shape of a fan, correspond to the number (six areas) of the symbol displaying area of the second displaying surface 37 and are fixed to the arms 33c annularly. In addition, a plurality of light-emitting diodes (LED) as an example of the lighting means 35 are provided to the front surface of each reflection plate 34.

(7) Means for Controlling

Reference numeral 39 is means for controlling the drive motor for orbital motion 12 and drive motor for rotation 21 respectively. The control means 39 is installed into the case 1 of the game machine X suitably. In addition, it may be provided at the backside of the supporting member 2 of the base corresponding to the design.

Since the concrete modes of the input part electrically connected with the control means 39, memory part 40 which are stored the program to carry out the game, position detection part for orbital motion and rotation and output part etc. are not the requirements which limit invention, the drawings and detailed explanation are omitted.

At this point, one example for operating (when it rotates on its axis after it orbits) of the control means 39 is explained simply. The control means 39 makes the drive motor 12 for orbital motion to start (orbit) on the basis of an order of an execution program 40a memorized into a memory part 40.

After that, the control means 39 makes the drive motor for orbital motion 12 to stop and makes the drive motor 21 for rotation to start (rotation) when it corresponds to the predetermined condition. After that, the control means 39 makes the drive motor 21 for rotation to stop.

In addition, other example (it rotates on its axis while it orbits) is explained simply. The control means 39 makes the drive motor 12 for orbital motion and drive motor 21 for rotation to start at the same time on the basis of an order of an execution program 40a memorized into a memory part 40. After that, it makes the drive motor 12 for orbital motion to stop and makes the drive motor 21 for rotation to stop finally.

As a matter as a matter of course, the control means 39 having a control part for the motor accesses to the memory part 40 and gets information from the memory part 40, and it starts the game while it controls the drive source (drive motor or driver) based on information of the random number generator, determining part for the symbols stopped, determining part for prize, detecting part for positioning the orbital motion and rotation when it makes the driving means 12, 21 (including the driver controlled by the motor control part when the displaying body is the electronic displaying device) to start and stop.

Accordingly, the symbol displaying unit for game machines of the present invention includes the large and small displaying bodies (for example, mechanical movable first displaying body, mechanical fixable or movable second displaying body, first displaying part and second displaying part of the screen of the electronic displaying device); the driving means capable of displaying (rotation or pseudo-rotation) the symbol of the small displaying body of the displaying body successively; means for controlling the drive of the driving means; the memory part 40 (RAM, ROM) which is connected to the control means electrically, storing the program 40a to start the game.

Additionally, the displaying surface 8 of the small displaying body 5 revolves to the displaying surface 37 of the large displaying body 31 (second displaying body) by driving force of the driving means 12 (drive motor or driver) for the orbital motion, and it rotates to the symbol of the displaying surface 37 of the displaying body 31 by driving force of the driving means 21 (drive motor or driver) for the rotation. After that, the symbol of the displaying surface 8 of the small displaying body 5 (first displaying body) and symbol of the displaying surface 37 of the large displaying body 31 are combined. According to the combination, it determines the prize status and points. In this embodiment, it decides the point at the same time it displays the dividend distribution.

For the above-mentioned structure, the displaying surface 37 of the large displaying body 31 is much larger than the displaying surface 8 of the small displaying body 5, and the center portion of the displaying body 5 always positions at eccentric to the axis O (center of the center shaft 15, for example) of the shaft at the side of the drive motor for orbital motion 12 and revolves in the range of the displaying body 31 and can rotates.

In addition, in this embodiment, the displaying surface of the small displaying body can revolve to the displaying surface of the large displaying body by driving force of the driving means for the orbit motion and rotate by driving force of the driving means for the rotation. Also it may be rotated and revolved in a reverse way.

(8) Means for Detecting Rotating Position

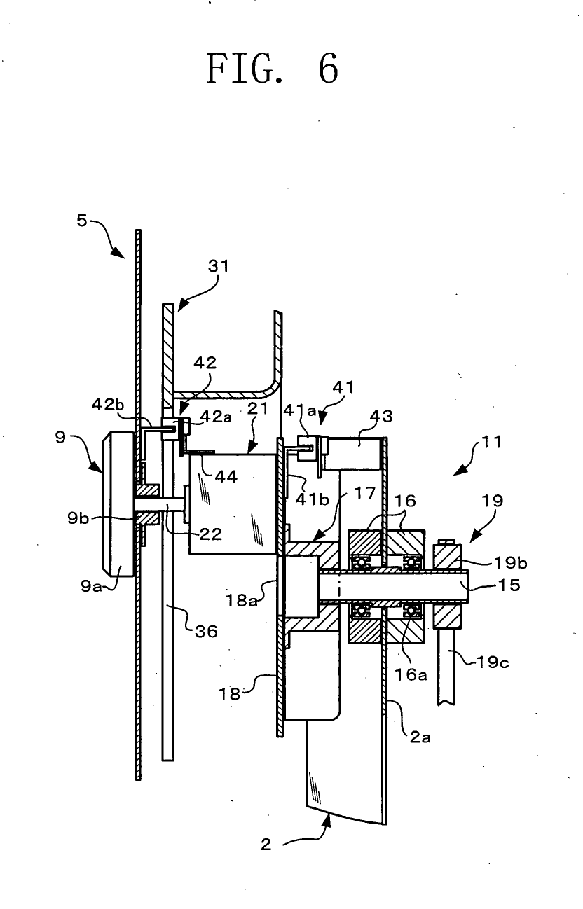

With reference to FIG. 6, the attachment places of the detecting means 41 for the orbital motion and detecting means 42 for the rotation are explained. The detecting means (attachment plate, sensor and index) which relates with the rotor plate 18 and first displaying body 5 has the relatively conventional. As a matter as a matter of course, the detecting means includes the devices with novelty.

A sensor 41a defined as the detecting means 41 for the rotor plate 18 is disposed at the upper portion of the perpendicular plate 2a of the supporting member 2 through an attachment piece 43. An index 41B is fixed suitably to the back at the circumferential end part of the rotor plate 18.

A sensor 42a which is defined as the detecting means 42 of the first displaying body 5 is disposed through an attachment piece 44 which is fixed the end part thereof to the sidewall of the outer side (at the side of the lighting means) of the drive motor for rotation 21 so as to position into the opening 36 of the second displaying body 31.

An index 42b is fixed suitably to the back of the first displaying body 5. In this way, when the detecting means 41, 42 are disposed at the upper part of the perpendicular plate 2a of the supporting member 2 or disposed at the outer side of the drive motor 21 through the attachment pieces 43, 44, it is easy to work the mounting of the detecting means, and it can detects the signal for the rotating position.

(9) Combibation of Symbols

FIG. 2 illustrates one example for combination of the displaying surfaces 8, 37 of the first displaying body 5 and second displaying body 31. As a matter as a matter of course, this combination of the symbols is not limited.

The symbol displaying unit Y for the game machine of the present invention is installed into the upper part of the game machine X as shown in FIG. 1, and it can be operated as the sub game and operated as the main game.

In this embodiment, the symbols (numbers, marks) which relates to the magnification of the dividend distribution are displayed at each symbol displaying area 8a, 8b and 37a, 37b of the displaying surface 8, 37.

For the combination mode of the game, for example, when the main game is carried out in the game machine X and takes the predetermined prize, the displaying unit Y of the present invention is started.

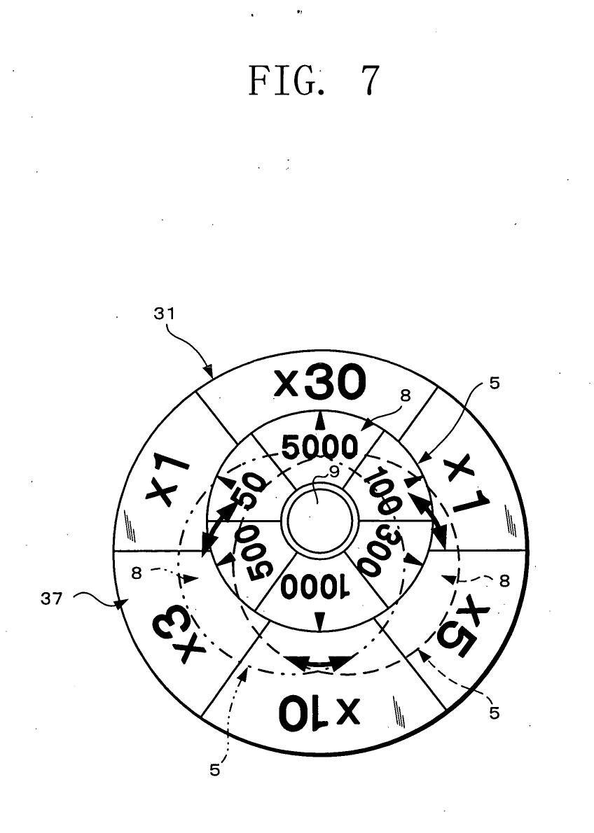

When the drive motors 12, 21 of the displaying unit Y are started at the same time for example, the small first displaying body 5 revolves in the circumferential direction and rotate at the same time (See FIG. 7) to the second displaying surface 37 of the large second displaying body 31 as described above. In this case, although the drive motor 21 starts after the drive motor 12 starts, it can say that the motors drive at the same time on the condition that the drive motor 12 drives.

In addition, the lighting and blinking of the lighting means 35 of the second displaying body 31 are carried out when the first displaying body 5 moves in front (or upper surface) of the second displaying body 31 for example. FIG. 2 shows an example showing the way in which the first displaying body 5 stops. In this case, when the lighting means 35 lights and blinks to only the symbol 37e of “x30” in the second displaying surface 37 of the second displaying body 31, the symbol 37e combines with the symbol 8a of “mark, 1000” in the first displaying surface 8 of the first displaying body 5, and the combination is decided as the dividend distribution of the game.

Accordingly, the dividend distribution is “150,000 points”. In this way, when the symbol in the first displaying surface 8 of the first displaying body 5 and the symbol in the second displaying surface 37 of the second displaying body 31 are combined, the player can get the high dividends.

(10) Second Embodiment

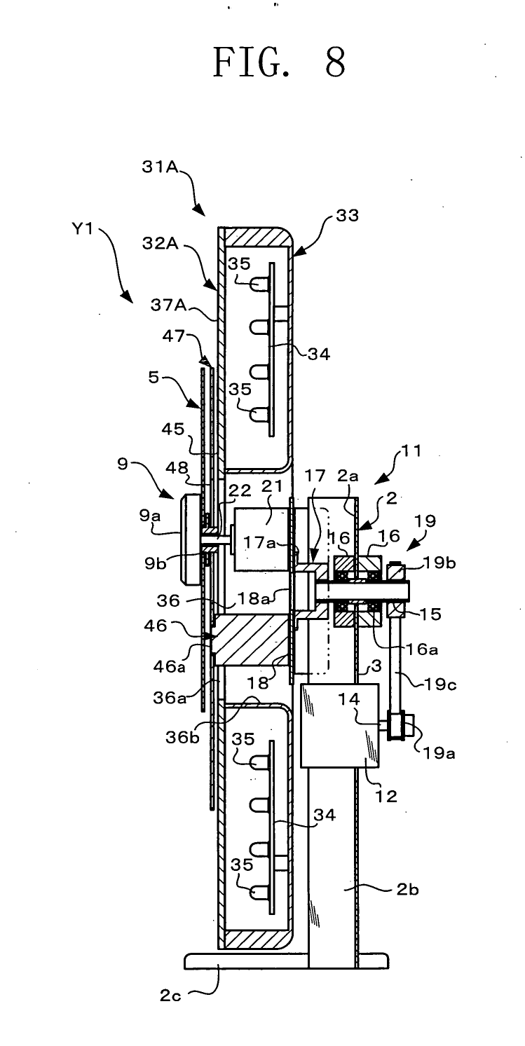

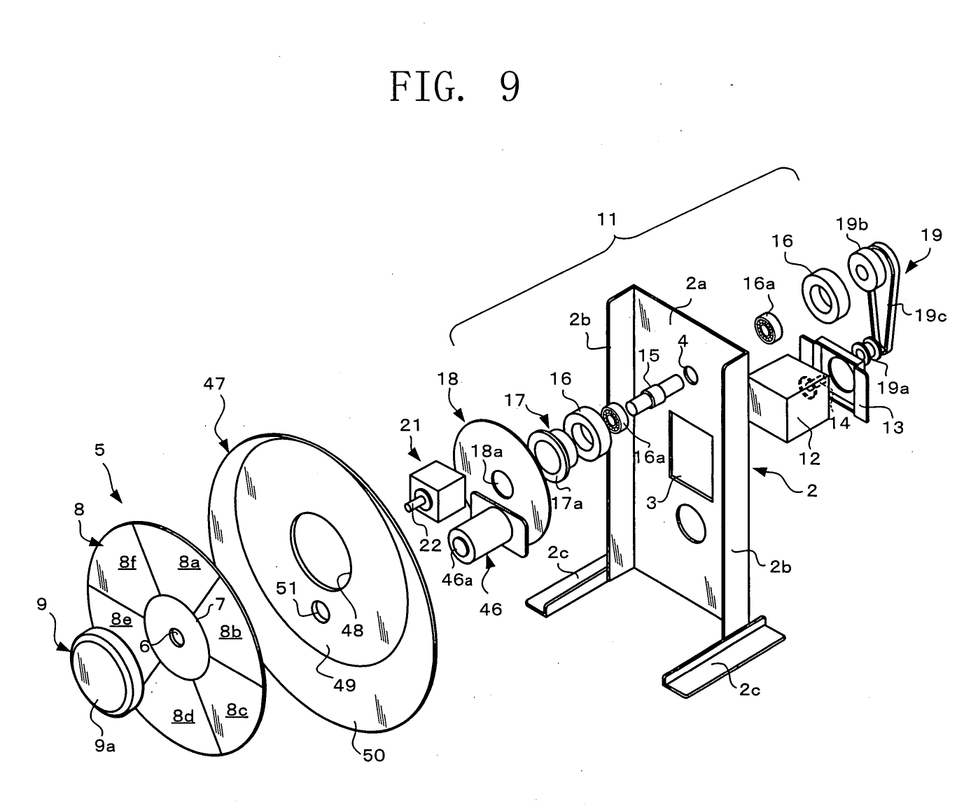

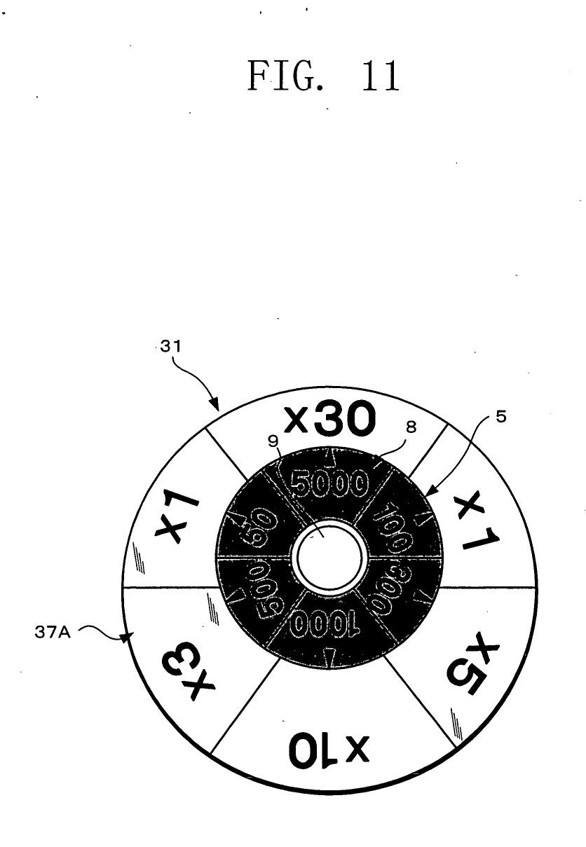

With reference to FIGS. 8 and 11, the second embodiment is explained. In addition, the components are denoted by like numerals as of the first embodiment and will not be further explained in great detail in this second embodiment.

The displaying unit Y1 in the second embodiment includes the main part described in the first embodiment and is added the object and elements.

For the second embodiment, the second displaying body 31A needs to include at least one lighting means 35. In addition, it also needs the transmissive part 45 associated with the lighting means 35.

Preferably, the plurality of the lighting means 35 are disposed at the reflection plate 34 in the annular direction as the first embodiment. In addition, the light irradiated from the lighting means 35 passes through the transmissive part 45 which is provided at the center part of the front plate 32A of the second displaying body 31A annularly.

The front plate 32A is comprised of the circular center opening 36a; the annular transmissive part 45 at inner side thereof; and an annular second displaying surface 37A at outer side thereof, connecting to the transmissive part 45. The second displaying surface 37A has the plurality of the symbol displaying areas 37a, 37b, 37c, 37d, 37e, 37f that are partitioned off in a radial pattern as the first embodiment. In this embodiment, these symbol displaying areas are defined as non-transmissive parts which do not pass the light. As a matter as a matter of course, According to the game, at least one symbol displaying area may be formed the transmissive part.

And now, the additional requirement of the second embodiment provides the object that the lighting means 35 of the second displaying body 31A illuminates only the first displaying surface 8 when it illuminates the first displaying surface 8 of the first displaying body 5 with the orbital motion through the transmissive part 45 of the front plate 32A of the second displaying body 31A. In other words, it does not illustrate the frill except for the first displaying surface 8.

Because the movement range of the first displaying body 5 is bigger than the radius of the first displaying body 5 (FIG. 7 and FIG. 11), the light irradiated from the lighting means 35 protrudes from the first displaying body 5. As a result, it illuminates unnecessary part except other than the first displaying surface 8 of the first displaying body 5, and it makes a bad show.

As shown in FIG. 8, so an annular shading plate 47 for the measures to the lighting is provided between the first displaying body 5 and second displaying body 31A in order to cover the moving range of the first displaying body 5 when in orbital motion, and the shading plate 47 and rotor plate 18 are connected integrally through means 46 for connecting.

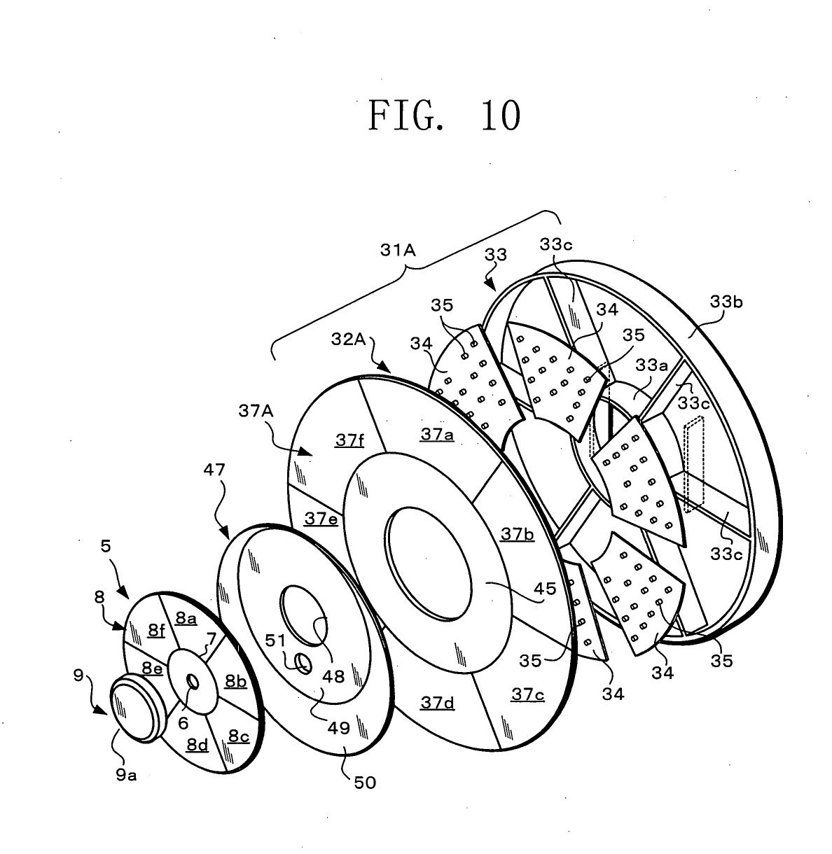

Accordingly, the shading plate 47 is formed the size which can cover the moving range of the first displaying body 5 when in orbital motion. The shading plate 47 that is shown in FIG. 10 illustrates one example of a second embodiment. The shading plate 47 is smaller than the front plate 32A of the second displaying surface 37A and is larger than the first displaying body 5.

The shading plate 47 further includes an eccentic hole 48 permitting to move the drive shaft 22 of the drive motor 21 for rotation; an annular transmissive part 49 having the same center of the eccentic hole 48; and a light shielding part 50 which connects to the outer part of the transmissive part 49, having outer circumferential end which is formed in the shape of circle. The light shielding part 50 protrudes at a curved state from the outer circumferential end of the transmissive part 49.

In addition, a small hole 51 is formed in the suitable portion of the transmissive part 49, engaging with the positioned projection that is provided at the tip surface of the connecting means 46. The detailed composition of the connecting means 46 is not limited element of the present invention. Then, the connecting means 46 has a predetermined length such that the shading plate 47 positioned between the first displaying body 5 and second displaying body 31A.

In addition, although the symbol is not put specifically, the connecting means 46 includes an attachment plate that is fixed at the front surface of the rotor plate 18 and attachment part that extends from the attachment plate, having a projection 46a and forming in the shape of a cylinder. The transmissive part 49, which is formed in the shape of a circle, is formed with small size a little bit rather than the first displaying body 5 preferably.

For the above-described structure, the first displaying body 5 is attached to the rotor plate 18 through the drive motor for rotation 21 integrally, and the shading plate 47 is attached to the rotor plate 18 integrally through the connecting means 46. Therefore, when the first displaying body 5 revolves, the shading plate 47 revolves with the first displaying body 5. In addition, when it revolves as shown in FIG. 11, only first displaying surface 8 is irradiated (meshed annular part) so that it makes a fine show.

(11) Third Embodiment

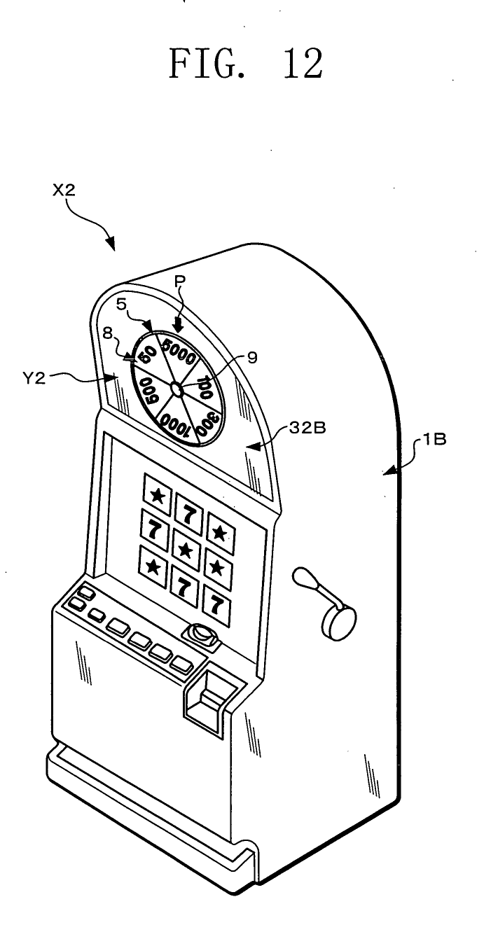

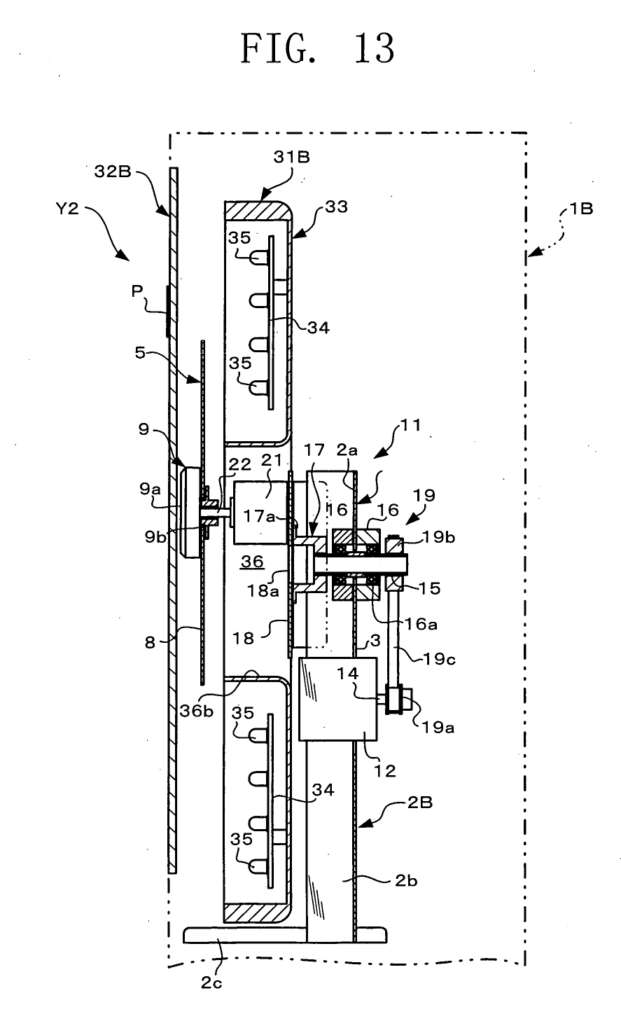

With reference to FIGS. 12 and 13, the third embodiment is explained. In addition, the components are denoted by like numerals as of the first embodiment and will not be further explained in great detail in this second embodiment.

The displaying unit Y2 of the third embodiment is distinguished from the first embodiment by the fact that the front plate 32 defined as the second displaying body 31 in the first embodiment is replaced with another transparent front plate 32B defined as a game machine X2.

In other words, as shown in FIG. 13, the second displaying body 31B installed into the case 1B through the supporting member 2B as a unit has the annular supporting plate 33, reflection plate 34 and lighting means 35, and there is no front plate 32B which displays the symbol for combination.

On the other hand, the front plate 32B having a function of the second displaying surface 37 is a transparent covering plate (glass plate, for example) which covers the first displaying surface 8 of the first displaying body 5.

Accordingly, the front plate 32B is provided at the front surface of the case 1B so as to position at the front of the first displaying body 5. In addition, in this embodiment, one symbol P (pointer, for example) for the combination is put the suitable place (in other words, the suitable place on the second displaying surface 37) that is positioned outside of the outer circumferential end of the first displaying surface 8.

In this way, the second displaying surface 37 of the second displaying body 31 in the first embodiment is replaced with the transparent front plate 32B of the game machine X2. The game machine X2 in this way according to the third embodiment has similar advantages to that according to the first embodiment.

### EXAMPLE

The following matters are added to the example that is shown in the embodiment of the present invention.

(1) In the embodiments, the displaying unit Y for symbol combination of the sub-game of the slot machine X is disclosed, and it is not limited for use. It may be used for the displaying unit for the game machines including Pachinko, other game machines and the like. In addition, the displaying unit Y may be used for the displaying unit for the main game by itself. Accordingly, it is available for any kinds of device.

(2) In the embodiments, the second displaying body is fixed and used for example, and it may have a rotating structure as same as the first displaying body. In this case, the transmitting methods of driving force of the driving means is not limited, for example, it includes to transmit by the belt provided at the outer circumferential part of the second displaying body, transmit by gears or other suitable methods. In addition, the displaying of the winning symbol is not only lighting also indicating the place pointed by the pointer provided at the suitable place as winning symbol.

(3) The number of displaying body does not apply only to the displaying body disclosed in the first and second embodiments. More than three (plurality) displaying bodies may be available.

(4) The shape of the displaying body does not apply only to the disc shape, and it may be formed in the shape of a polygon, other shapes and the like. In addition, it may be formed in any size.

(5) The small displaying body may revolve and rotate at the same time (coincidence), and it may revolve and rotate in order (random order). In addition, it may rotate after it revolves (intertemporal theory).

(6) The symbol of the present invention includes numbers of dividend distribution and magnification, marks, figures, patterns, colors and the like, and the symbols which are put to each displaying body may be set suitably according to the content of the game. In addition, the element of gambling is applied suitably so that it is not limited in the above-mentioned embodiments.

As set forth above, the advantages of the invention are as follows:

(1) Since the small first displaying body can revolve and rotate to the displaying surface of the large displaying body, it has a strong appeal to the player visually. Accordingly, it can be operated in many ways depending on execution program of the game machine. In addition, although there is a different structure, in other words, the large displaying body revolves and rotates to the displaying surface of the small displaying body, it has similar advantages to that according to the embodiment of the present invention when the drive motor for orbital motion and drive motor for rotation are provided independently and separately.

(2) For the embodiment of the present invention, the small first displaying body revolves and rotates in the area of the large displaying body so that it can raise the hopes of the players for dividend distribution of the games and it allows the player to excite until the first displaying body stops completely.

(3) For the embodiment(s) disclosed the lighting means, since the lighting shines when the movable displaying body revolves, it makes a change. However, the lighting means is not limited.

(4) For the embodiment(s) disclosed the shading plate for the measures to the lighting, since the lighting of the lighting means when in orbital motion is shined on the movable displaying body (first displaying surface 8 in the embodiment) only, it makes a fine show. However, the shading plate for the measures to the lighting is not limited.

(5) It can install into a chassis (case) easily. Therefore, it can improve the operating efficiency of the manufacturing.

### INDUSTRIAL APPLICABILITY

The present invention is utilized in the game business mainly.

1-6. (canceled)

7. A symbol displaying unit for a game machine having a first displaying body and a second displaying body capable of combining symbols, and means for driving the displaying bodies mounted on a supporting member and allowing at least either said first displaying body or said second displaying body to be driven and to rotate, the displaying unit comprising,
a second displaying surface of said second displaying body appearing from an outer circumferential edge of a first displaying surface of said first displaying body; and
said first displaying body, capable of revolving against said second displaying surface of said second displaying body when a drive motor, defining as an eccentric revolving mechanism, for orbital motion drives and capable of rotating when a drive motor for rotation drives.

8. The symbol displaying unit for a game machine according to claim 7, wherein said supporting member comprises a rotor plate, defining as said eccentric revolving mechanism, for eccentric rotation, and said drive motor for rotation is fixed to an eccentric position of said rotor plate.

9. The symbol displaying unit for a game machine according to claim 7, further comprising:
means for lighting; and
a shading plate for the measures to lighting, which is disposed at said rotor plate, defining as said eccentric revolving mechanism, for eccentric rotation and positioned between said first displaying body and said second displaying surface through means for connecting, rotating with said first displaying body at the same time.

10. The symbol displaying unit for a game machine according to claim 7, each member comprising said eccentric revolving mechanism is provided at sides of a front surface and a back surface of one base supporting member as a unit.

11. A symbol displaying unit for a game machine having a plurality of displaying bodies and means for driving the displaying bodies, allowing at least one displaying body to display successively, the displaying unit comprising,
a large displaying body and a small displaying body, said small displaying body having a displaying surface capable of revolving against a displaying surface of said large displaying body by driving force of said driving means including means for driving for orbital motion and rotating by means for driving for rotation.

12. The symbol displaying unit for a game machine according to claim 11, wherein a center portion of said small displaying body is always positioned eccentrically relative to an axis O of a shaft at a side of said drive motor for orbital motion, capable of revolving and rotating in the range of said large displaying body.
